(19) United States
(12) Patent Application Publication
(10) Pub. No.: US 2021/0404983 A1
(43) Pub. Date: Dec. 30, 2021

(54) DETECTION CIRCUIT FOR DISPLAY PANEL AND DETECTION METHOD THEREOF

(71) Applicant: WUHAN CHINA STAR OPTOELECTRONICS TECHNOLOGY CO., LTD., Wuhan, Hubei (CN)

(72) Inventor: Chunpeng Guo, Wuhan, Hubei (CN)

(21) Appl. No.: 16/623,718

(22) PCT Filed: Sep. 9, 2019
(86) PCT No.: PCT/CN2019/104840

§ 371 Date: Dec. 17, 2019

(30) Foreign Application Priority Data
Jun. 13, 2019 (CN) 201910508651.4

(51) Int. Cl. G01N 27/20; G01N 27/04

(52) U.S. Cl. CPC G01N 27/20; G01N 27/045

(57) ABSTRACT

A detection circuit for a display panel that includes a display panel, a flexible printed circuit board (PCB) adapter, and a module lighting fixture, wherein the display panel includes a display area and a non-display area, and the non-display area further accommodates a detection signal wire and a driving integrated circuit (IC). The flexible PCB adapter is disposed at a pin wire of a receiving terminal of the detection signal wire between the display panel and the module lighting fixture. The module lighting fixture is disposed at one end of the flexible PCB adapter.

### CROSS-REFERENCE TO RELATED APPLICATIONS

This application the National phase under 35 U.S.C. § 371 of International Application No. PCT/CN2019/104840, filed Sep. 9, 2019, which claims the benefit of and priority to Chinese Patent Application No. 201910508651.4, filed Jun. 13, 2019. The entire contents of these patent applications are hereby incorporated by reference herein.

### FIELD OF INVENTION

The present application relates to the field of display, and especially to a detection circuit for a display panel and a detection method thereof.

### BACKGROUND OF INVENTION

With rapid development of modern technologies and change of people's aesthetic appreciation, the extent to which the screen-to-body ratio of a cell phone screen can reach has become more and more important a point which people concern themselves with. Screen-to-body ratios of mainstream flagship phones in the present market are mostly up to 90% or even higher, which makes size of a display area larger and larger, and appearance of cell phones also becomes more and more exquisite.

A challenge of cell phone panels adopting a chip on glass (COG, chip is directly bonded on glass) process in the conventional technology to increase screen-to-body ratios mainly relates to lower borders of the panels, because it is necessary to put driving integrated circuits (ICs) of the panels through a chip bonding process to bond the driving ICs on glass. Driving ICs necessarily occupy a certain amount of area due to need to realize driving of gate, source, and drain of panels and graphic processing and other functions, and hence it is limited to reduce size of lower borders of display panels.

Now mainstream cell phone clients would ask panel suppliers to detect if display panels have broken screens before they go out to ensure yields of panels and avoid risk of broken screens. A circle of metal wire is disposed around the edge of a panel, one end of which is connected to a signal transmitting terminal of a driving IC, and the other end is connected to a signal receiving terminal of the driving IC. If the display panel is normal, then signals transmitted by the driving IC are received by the signal receiving terminal of the driving IC through the metal wire around the edge of the display panel, which means the display panel is not broken. If the display panel is broken, then the signal receiving terminal of the driving IC will not receive signals transmitted by the transmitting terminal of the driving IC, which realizes detection of whether or not display panels have broken screens.

Therefore, detection circuits of display panels in the conventional technology still have a problem that a detection circuit of a display panel is disposed in the display panel, limits size reducing of lower borders of display panels, and decreases screen-to-body ratios of display panels, which is in urgent need of improvement.

### SUMMARY OF INVENTION

The present application relates to a detection circuit for a display panel and a detection method thereof, which is used to resolve a problem of the conventional technology that a detection circuit of a display panel is disposed in the display panel, limits size reducing of lower borders of display panels, and decreases screen-to-body ratios of display panels.

In order to resolve the above-mentioned problem, the present application provides a technical approach that follows.

A detection circuit for a display panel according to the present application includes a display panel, a flexible printed circuit board (PCB) adapter, and a module lighting fixture, wherein the display panel includes a display area and a non-display area, and the non-display area further accommodates a detection signal wire, a flexible PCB, and a driving integrated circuit (IC). The flexible PCB adapter is disposed at a pin wire of a receiving terminal of the detection signal wire between the display panel and the module lighting fixture. The module lighting fixture is disposed at one end of the flexible PCB adapter to make the detection circuit for a display panel form a closed loop that detects whether there is a crack on the display panel or not.

In an advantageous embodiment according to the present application, area of the display area is greater than area of the non-display area.

In an advantageous embodiment according to the present application, the non-display area is separated into a first non-display area, a second non-display area, a third non-display area, and a fourth non-display area.

In an advantageous embodiment according to the present application, the detection signal wire includes a detection signal receiving terminal and a detection signal transmitting terminal.

In an advantageous embodiment according to the present application, the detection signal wire is disposed at the first non-display area, the second non-display area, and the third non-display area, and the detection signal receiving terminal and the detection signal transmitting terminal are both let out from the fourth non-display area.

In an advantageous embodiment according to the present application, the detection signal transmitting terminal is directly grounded, and the detection signal receiving terminal is electrically connected to a ground pin at the flexible PCB adapter.

In an advantageous embodiment according to the present application, the flexible PCB adapter, the detection signal wire, and the module lighting fixture are in series with each other.

In an advantageous embodiment according to the present application, a detection resistor is disposed on the flexible PCB adapter.

In an advantageous embodiment according to the present application, resistance of the detection resistor is 8,000 ohms, and input voltage of the module lighting fixture is 3V.

The present application further provides a detection method for a detection circuit of a display panel, wherein the display panel includes a display area and a non-display area, the non-display area further includes a detection signal wire, a flexible PCB, and a driving integrated circuit (IC), the detection signal wire is separated into a detection signal receiving terminal and a detection signal transmitting terminal, and the method includes the following steps: S10, providing a detection circuit of a display panel, a flexible PCB adapter, and a module lighting fixture. S20, electrically connecting one terminal of the flexible PCB adapter to the detection signal receiving terminal of the detection circuit of the display panel. S30, electrically connecting other terminal of the flexible PCB adapter to a voltage input terminal of the module lighting fixture. S40, using a measuring instrument to measure a voltage value of a voltage test terminal.

In comparison with the conventional technology, a detection circuit for a display panel and a detection method thereof according to the present application have the following beneficial effects:

1. The detection circuit for a display panel according to the present application shifts a detection function module originally located in a driving IC and realizes it outside of the driving IC, which decreases volume of the driving IC and really attains an extremely narrow border.

2. The detection method for a display panel according to the present application requires only a flexible printed circuit board adapter and a module lighting fixture exteriorly connected, the wiring is simple, and the method is simple and easily performed.

3. An outside circle around a display panel is directly grounded and is not easily interfered by exterior static, which can produce an effect of electrostatic protection.

### DESCRIPTION OF DRAWINGS

The accompanying figures to be used in the description of embodiments of the present application will be described in brief to more clearly illustrate the technical solutions of the embodiments. The accompanying figures described below are only part of the embodiments of the present application, from which those skilled in the art can derive further figures without making any inventive efforts.

FIG. 1 is a structural schematic diagram of a detection circuit for a display panel according to an embodiment of the present application.

FIG. 2 is a flow chart of a detection method for a display panel according to an embodiment of the present application.

### DETAILED DESCRIPTION OF PREFERRED EMBODIMENTS

The embodiments of the present application are described in detail hereinafter. Examples of the described embodiments are given in the accompanying drawings. It should be noted that the following embodiments are intended to illustrate and interpret the present application, and shall not be construed as causing limitations to the present application. Similarly, the following embodiments are part of the embodiments of the present application and are not the whole embodiments, and all other embodiments obtained by those skilled in the art without making any inventive efforts are within the scope protected by the present application.

In description of the present application, it should be understood that terms that indicates orientation or relation of position such as “center”, “longitudinal”, “lateral”, “length”, “width”, “thickness”, “upper”, “lower”, “front”, “rear”, “left”, “right”, “vertical”, “horizontal”, “top”, “bottom”, “interior”, “exterior”, “clockwise”, “counterclockwise” are based on orientation or relation of position accompanying drawings show. They are simply for purpose of description of the present application and simplifying of description, and does not mean or suggest the devices or components have a specified orientation and constructed and operated in a specified orientation; therefore, it should not be understood as limitation of the present application. Furthermore, terms “first” and “second” are used simply for purpose of description and cannot be understood to mean or suggest relative importance or implicitly mean amount of the technical features. Therefore, features with terms “first” and “second” can mean or implicitly include one or more of the features. In description of the present application, “multiple” means two or more unless otherwise clearly and concretely specified.

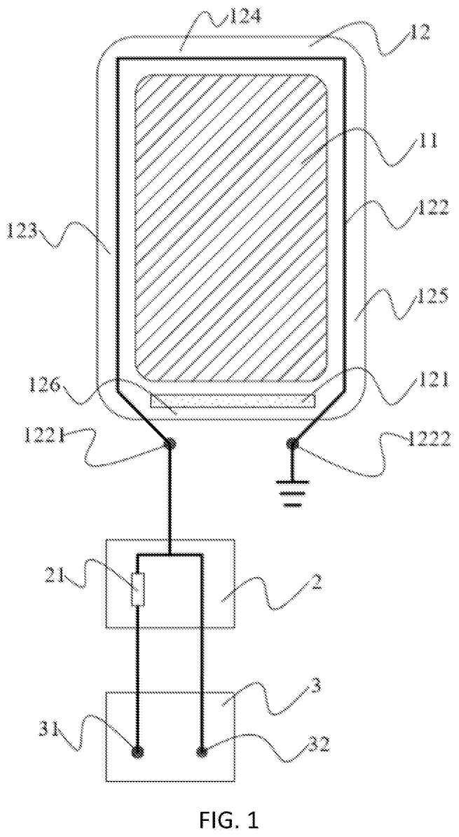

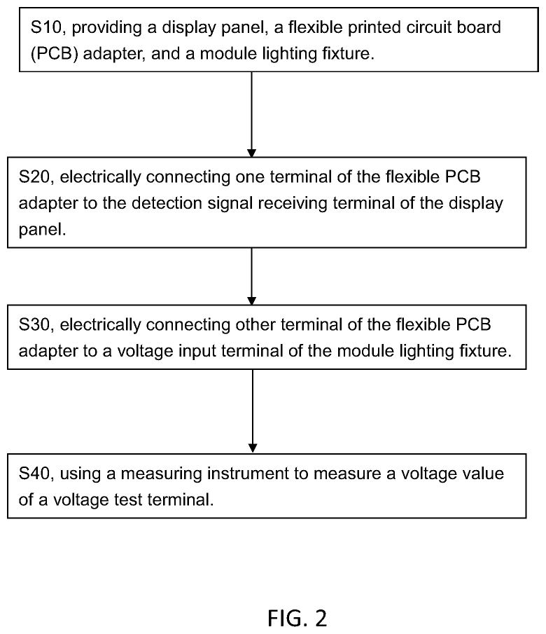

Referring to FIG. 1 and FIG. 2, the present application provides a detection circuit for a display panel and a detection method thereof.

Referring to FIG. 1, FIG. 1 is a structural schematic diagram of a detection circuit for a display panel according to an embodiment of the present application that includes a display panel 1 (not shown), a flexible printed circuit board (PCB) adapter 2, and a module lighting fixture 3. Wherein, the display panel 1 is separated into a display area 11 and a non-display area 12, and the display area 11 is used to display pictures. The non-display area 12 accommodates a driving integrated circuit (IC) 121 and a detection signal wire 122. The flexible PCB adapter 2 is disposed at a pin wire of a receiving terminal 1221 of the detection signal wire 122 between the display panel 1 and the module lighting fixture 3. The module lighting fixture 3 is disposed at one end of the flexible PCB adapter 2 to make the detection circuit for the display panel 1 form a closed loop that detects if there is crack on the display panel 1.

In the present embodiment, the display panel 1 is a rectangle, the display area 11 is disposed at a center area of the display panel 1, the non-display area 12 is disposed around the display area 11, and area of the display area 11 of the display panel 1 is greater than area of the non-display area 12. The non-display area 12 is separated into a first non-display area 123, a second non-display area 124, a third non-display area 125, and a fourth non-display area 126. The first non-display area 123 is disposed facing the third non-display area 125, and the second non-display area 124 is disposed facing the fourth non-display area 126. The first non-display area 123 and the third non-display area 125 have a same size and shape, the second non-display area 124 and the fourth non-display area 126 have a same shape, and area of the second non-display area 124 is less than or equal to area of the fourth non-display area 126. The driving IC 121 is disposed at a lower border of the display panel 1, that is, in the fourth non-display area 126.

Furthermore, the detection signal wire 122 includes a detection signal receiving terminal 1221 and a detection signal transmitting terminal 1222. The detection signal wire 122 covers at the first non-display area 123, the second non-display area 124, and the third non-display area 125, and the detection signal receiving terminal 1221 and the detection signal transmitting terminal 1222 are let out through the fourth non-display area 126. The detection signal transmitting terminal 1222 is directly grounded, and the detection signal receiving terminal 1221 is electrically connected to a ground pin at the flexible PCB adapter 2.

The flexible PCB adapter 2, the detection signal wire 122, and the module lighting fixture 3 are in series with each other. A detection resistor 21 is further disposed on the flexible PCB adapter 2. A voltage input terminal 31 of the module lighting fixture 3 and a voltage test terminal 32 of the module lighting fixture 3 are disposed on the module lighting fixture 3. Resistance of the detection resistor 21 is eight thousand ohms, and input voltage of the module lighting fixture 3 is three volts.

Referring to FIG. 2, the present application further provides a detection method for a display panel, the method includes the following steps: S10, providing a display panel 1, a flexible PCB adapter 2, and a module lighting fixture 3. S20, electrically connecting one terminal of the flexible PCB adapter 2 to a detection signal receiving terminal 1221 of the display panel 1. S30, electrically connecting other terminal of the flexible PCB adapter 2 to a voltage input terminal 31 of the module lighting fixture 3. S40, using a measuring instrument to measure a voltage value of a voltage test terminal 32. The measuring instrument is a multimeter or a voltmeter.

In comparison with the conventional technology, beneficial effects of a detection circuit for a display panel and a detection method thereof according to the present application are that, first, the detection circuit for a display panel according to the present application shifts a detection function module originally located in a driving IC and realizes it outside of the driving IC, which decreases volume of the driving IC and really attains an extremely narrow border. Second, the detection method for a display panel according to the present application requires only a flexible printed circuit board adapter and a module lighting fixture exteriorly connected, the wiring is simple, and the method is simple and easily performed. Finally, an outside circle around the display panel is directly grounded and is not easily interfered by exterior static, which can produce an effect of electrostatic protection.

Although the present application has been explained in relation to its preferred embodiment, it does not intend to limit the present application. It will be apparent to those skilled in the art having regard to this present application that other modifications of the exemplary embodiments beyond these embodiments specifically described here may be made without departing from the spirit of the application. Accordingly, such modifications are considered within the scope of the application as limited solely by the appended claims.

What is claimed is:

1. A detection circuit for a display panel, comprising a display panel, a flexible printed circuit board (PCB) adapter, and a module lighting fixture, wherein
the display panel is rectangular and includes a display area and a non-display area, and the non-display area accommodates a detection signal wire and a driving integrated circuit (IC);
the flexible PCB adapter is disposed at a pin wire of a receiving terminal of the detection signal wire between the display panel and the module lighting fixture;
the module lighting fixture is disposed at one end of the flexible PCB adapter to make the detection circuit for a display panel form a closed loop and detect whether there is a crack on the display panel or not.

2. The detection circuit for a display panel as claimed in claim 1, wherein area of the display area is greater than area of the non-display area.

3. The detection circuit for a display panel as claimed in claim 2, wherein the non-display area is separated into a first non-display area, a second non-display area, a third non-display area, and a fourth non-display area.

4. The detection circuit for a display panel as claimed in claim 1, wherein the detection signal wire comprises a detection signal receiving terminal and a detection signal transmitting terminal.

5. The detection circuit for a display panel as claimed in claim 4, wherein the detection signal wire is disposed at the first non-display area, the second non-display area, and the third non-display area, and the detection signal receiving terminal and the detection signal transmitting terminal are both let out from the fourth non-display area.

6. The detection circuit for a display panel as claimed in claim 4, wherein the detection signal transmitting terminal is directly grounded, and the detection signal receiving terminal is electrically connected to a ground pin at the flexible PCB adapter.

7. The detection circuit for a display panel as claimed in claim 1, wherein the flexible PCB adapter, the detection signal wire, and the module lighting fixture are in series with each other.

8. The detection circuit for a display panel as claimed in claim 7, wherein a detection resistor is disposed on the flexible PCB adapter.

9. The detection circuit for a display panel as claimed in claim 8, wherein resistance of the detection resistor is eight thousand ohms, and input voltage of the module lighting fixture is three volts.

10. A detection circuit for a display panel, comprising a display panel, a flexible printed circuit board (PCB) adapter, and a module lighting fixture, wherein
the display panel includes a display area and a non-display area, and the non-display area further accommodates a detection signal wire and a driving integrated circuit (IC);
the flexible PCB adapter is disposed at a pin wire of a receiving terminal of the detection signal wire between the display panel and the module lighting fixture;
the module lighting fixture is disposed at one end of the flexible PCB adapter to make the detection circuit for a display panel form a closed loop that detects whether there is a crack on the display panel or not.

11. The detection circuit for a display panel as claimed in claim 10, wherein area of the display area is greater than area of the non-display area.

12. The detection circuit for a display panel as claimed in claim 11, wherein the non-display area is separated into a first non-display area, a second non-display area, a third non-display area, and a fourth non-display area.

13. The detection circuit for a display panel as claimed in claim 10, wherein the detection signal wire comprises a detection signal receiving terminal and a detection signal transmitting terminal.

14. The detection circuit for a display panel as claimed in claim 13, wherein the detection signal wire is disposed at the first non-display area, the second non-display area, and the third non-display area, and the detection signal receiving terminal and the detection signal transmitting terminal are both let out from the fourth non-display area.

15. The detection circuit for a display panel as claimed in claim 13, wherein the detection signal transmitting terminal is directly grounded, and the detection signal receiving terminal is electrically connected to a ground pin at the flexible PCB adapter.

16. The detection circuit for a display panel as claimed in claim 10, wherein the flexible PCB adapter, the detection signal wire, and the module lighting fixture are in series with each other.

17. The detection circuit for a display panel as claimed in claim 16, wherein a detection resistor is disposed on the flexible PCB adapter.

18. The detection circuit for a display panel as claimed in claim 17, wherein resistance of the detection resistor is eight thousand ohms, and input voltage of the module lighting fixture is three volts.

19. A detection method for a detection circuit of a display panel, wherein the display panel includes a display area and a non-display area, the non-display area further comprises a detection signal wire and a driving integrated circuit (IC), the detection signal wire is separated into a detection signal receiving terminal and a detection signal transmitting terminal, and the method comprises the following steps:
S10, providing a detection circuit of a display panel, a flexible printed circuit board (PCB) adapter, and a module lighting fixture;
S20, electrically connecting one terminal of the flexible PCB adapter to the detection signal receiving terminal of the detection circuit of the display panel;
S30, electrically connecting other terminal of the flexible PCB adapter to a voltage input terminal of the module lighting fixture;
S40, using a measuring instrument to measure a voltage value of a voltage test terminal.

20. The detection method for a detection circuit of a display panel as claimed in claim 19, wherein the measuring instrument is a multimeter or a voltmeter.
